(19) United States
(12) Patent Application Publication
(10) Pub. No.: US 2002/0080953 A1
(43) Pub. Date: Jun. 27, 2002

(54) DTMF DECODER

(76) Inventor: HIROAKI HARADA, MINATO-KU (JP)

Correspondence Address: VENABLE, P.O. Box 34385, WASHINGTON, DC, 20043-9998, US

(21) Appl. No.: 09/369,191

(22) Filed: Aug. 6, 1999

(30) Foreign Application Priority Data
Aug. 18, 1998 (JP) 231892/98

(51) Int. Cl. H04M 1/00; H04M 3/00

(52) U.S. Cl. 379/386

(57) ABSTRACT

The invention is to provide a DTMF decoder having a minimum power consumption. A signal inputted to a digital demodulator of the invention is respectively inputted to a bandpass filter for a DTMF signal of a low frequency band, a bandpass filter for a DTMF signal of a high frequency band, a bandpass filter for a DTMF signal of a middle frequency band, and levels of signals passed through respective filters are measured by a level measuring device for the DTMF signal of a low frequency band, a level measuring device for the DTMF signal of a high frequency band, and a level measuring device for the DTMF signal of a middle frequency band. The digital demodulator of the invention decides that the DTMF signal is included in the digital signal if it can be decided that the output level of the level measuring device for the DTMF signal of the low frequency band, and that of the level measuring device for DTMF signal of the high frequency band have respectively more than given levels and substantially the same levels and that of the level measuring device for the DTMF signal of the middle frequency band is scarcely present.

### BACKGROUND OF THE INVENTION

1. Field of the Invention

The invention relates to a DTMF (Dual Tone Multi Frequency) detecting circuit for detecting the presence of a DTMF signal composed of a combination of a signal of a low frequency band and a signal of a high frequency band, and a DTMF decoder for analyzing the DTMF signal.

2. Description of the Related Art

A DTMF signal is obtained by synthesizing a signal having one frequency of 4 kinds of high tone frequencies (1209 Hz, 1336 Hz, 1477 Hz, 1633 Hz) belonging to a high frequency band and a signal having one frequency of 4 kinds of low tone frequency (697 Hz, 770 Hz, 852 Hz, 941 Hz) belonging to a low frequency band.

A conventional DTMF decoder is provided with 8 bandpass filters corresponding to the 8 kinds of tone frequencies as set forth above and 8 level measuring devices which are paired with these 8 bandpass filters. A signal inputted to the DTMF decoder is converted into a digital signal, and this digital signal is inputted to the 8 bandpass filters. Respective signals passed through the respective bandpass filters are outputted from respective bandpass filters. These passed signals are inputted to level measuring devices which are paired with the bandpass filters. Respective level measuring devices detect and output levels of the passed signals of corresponding passbands.

Two level measuring devices which output levels having more than a given value for more than a given time (40 ms according to DTMF standard) are selected. A signal obtained by combining two passed signals of two passbands corresponding to the selected level measuring devices is a DTMF signal included in the input signal. The DTMF decoder outputs a numeral corresponding to this DTMF signal.

In the conventional DTMF decoder, there are needed an operation at bandpass filters and an operation at level measuring devices for all tone frequencies at each process of detecting the DTMF signal. Since the adjacent tone frequencies are close to each other, bandpass filters employed by the conventional DTMF decoder needs to accurately operate the passed signals, and hence the volume of operations becomes large. Further, unnecessary volume of operations becomes large because an input signal having no DTMF signal is subject to an operation at 8 bandpass filters and to an operation at 8 level measuring devices.

### SUMMARY OF THE INVENTION

It is an object of the invention to provide a DTMF decoder having small volume of operations with less power consumption.

To achieve the above object, the problems of the conventional DTMF decoder has been solved by providing the following featured means. That is, the DTMF decoder of the invention is characterized in comprising a first bandpass filter for extracting a signal of a low frequency band from an input signal, a second bandpass filter for extracting a signal of a high frequency band from the input signal, a third bandpass filter for extracting a signal of a middle frequency band from the input signal, a first level measuring device for measuring a level of the signal of the low frequency band and outputting the same level, a second level measuring device for measuring a level a third level measuring device for measuring a level of the signal of the middle frequency band and outputting the same level, and a comparison decision circuit for deciding that a DTMF signal is included in the input signal in case where the level of the signal of the low frequency band is substantially the same as that of the high frequency band while the levels of the signals of the low frequency band and high frequency band are higher than respective given values and the level of the signal of the middle frequency band is lower than a given value, and also decides that the DTMF signal is not included in other cases.

### BRIEF DESCRIPTION OF THE DRAWINGS

FIG. 1 is a view showing the construction of a DTMF decoder according to a first embodiment of the invention;

FIG. 2 is a view showing the construction of a DTMF decoder according to a second embodiment of the invention; and

FIG. 3 is a view showing the construction of a DTMF decoder according to a third embodiment of the invention.

### DETAILED DESCRIPTION OF THE PREFERRED EMBODIMENTS

The first embodiment utilizers the fact that a DTMF signal is a combination of a signal of a high frequency band and a signal of a low frequency band respectively having the same level.

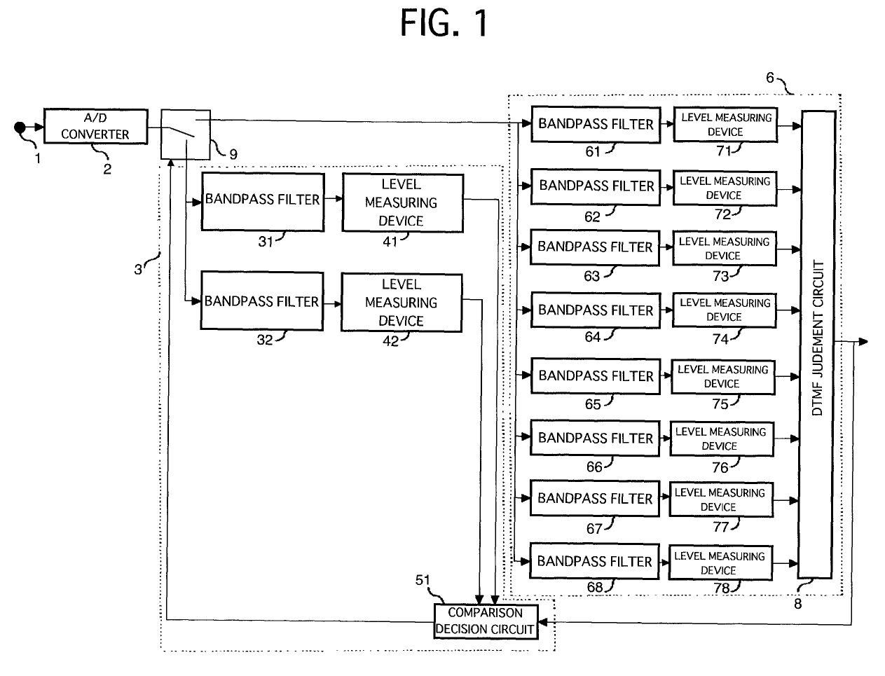

FIG. 1 is a view showing the construction of the DTMF decoder according to the first embodiment of the invention.

In the DTMF decoder, if a DTMF signal is included in an input signal, the DTMF signal is judged and outputted. If the DTMF signal is not included in the input signal, nothing is outputted.

The DTMF decoder according to the first embodiment of the invention comprises an input terminal 1, an A/D converter 2, a DTMF detecting circuit 3, and a DTMF decoder 6 having the same construction of a conventional DTMF decoder.

The DTMF detecting circuit 3 comprises a bandpass filter 31 having a passband of a low tone frequency (697 Hz to 941 Hz), a bandpass filter 32 having a high tone frequency (1209 Hz to 1633 Hz), a level measuring device 41, a level measuring device 42 and a comparison decision circuit 51.

The DTMF decoder 6 comprises bandpass filters 61 to 64 having passbands which are set at each low tone frequency, bandpass filters 65 to 68 having passbands which are set at each high tone frequency, level measuring devices 71 to 74 corresponding to respective bandpass filters 61 to 64, level measuring devices 75 to 78 corresponding to respective bandpass filters 65 to 68, a DTMF judgment circuit 8 and a switch for switching between output destinations.

The operation of the DTMF decoder according to the first embodiment of the invention is now described.

In the initial state, the switch 9 is set in the manner that an output of the A/D converter 2 is inputted to the bandpass filter 31 and the bandpass filter 32.

An input signal from the input terminal 1 is converted into a digital signal by the A/D converter 2. The digital signal is inputted to the bandpass filter 31 and the bandpass filter 32.

The digital signal passes through the bandpass filter 31. The bandpass filter 31 outputs a passed signal of the low tone frequency. The passed signal is inputted to the level measuring device 41. The bandpass filter 32 outputs a passed signal of the high tone frequency and the passed signal is inputted to the level measuring device 42.

The level measuring device 41 and level measuring device 42 detect levels of the inputted passed signals and output these levels. Two kinds of levels are respectively inputted to the comparison decision circuit 51.

The comparison decision circuit 51 decides that the DTMF signal is included in the digital signal in case where the output level of the level measuring device 41 and that of the level measuring device 42 are higher than a given value at the same time and are substantially the same. In other cases, the comparison decision circuit 51 decides that the DTMF signal is not included in the digital signal. The comparison decision circuit 51 switches the switch 9 immediately after deciding that the DTMF signal is included in the digital signal so as to allow the digital signal outputted from the A/D converter 2 to be inputted to the DTMF decoder 6. The comparison decision circuit 51 keeps monitoring the levels outputted from the level measuring device 41 and level measuring device 42 when deciding that the DTMF signal is not included in the digital signal.

When the switch 9 is switched to the DTMF decoder 6, the digital signal outputted from the A/D converter 2 is inputted to the bandpass filters 61 to 68. The bandpass filters 61 to 68 output passed signals of respective passbands when the digital signal passes therethrough. The passed signals are inputted to the level measuring devices 71 to 78 connected to the bandpass filters 61 to 68. The level measuring devices 71 to 78 detect levels of the passed signals of the corresponding passbands and output these levels.

Two level measuring devices which output levels having more than a given value for more than a given time (40 ms according to DTMF standard) are selected by the DTMF judgment circuit 8. A signal obtained by combining two passed signals of two passbands corresponding to the selected level measuring devices is a DTMF signal included in the input signal. The DTMF judgment circuit 8 outputs a numeral corresponding to the DTMF signal as an output of the DTMF decoder of the invention.

If the number of level measuring device output levels of which are more than a give value for more than a given time (40 ms according to the DTMF standard) is other than two, the DTMF judgment circuit 8 decides that the signal inputted to the DTMF decoder 6 is not the DTMF signal and it does not output anything.

The output of the DTMF judgment circuit 8 is also inputted to the comparison decision circuit 51. The comparison decision circuit 51 switches the switch 9 so that the output of the A/D converter 2 is inputted to the bandpass filters 31 and 32 if a numeral corresponding to the DTMF signal is outputted from the DTMF judgment circuit 8 or an output from the DTMF judgment circuit 8 is not present for more than a given time (e.g. 50 ms) after the switch 9 is switched. That is, the decoding of the DTMF signal relative to the next input signal starts.

Accordingly, in the DTMF decoder of the first embodiment of the invention, the DTMF signal is not normally decoded but decoded only in case where the DTMF signal is detected by the DTMF detecting circuit 3. Since the decision of the presence of the DTMF signal is performed using bandpass filters number of which is less than that of the DTMF decoder 6, the power consumption of the DTMF decoder of the first embodiment of the invention is less than that of the conventional DTMF decoder.

The second embodiment utilizes the fact that a DTMF signal is a combination of a signal of a high frequency band and a signal of a low frequency band respectively having the same level and a signal of a middle frequency band positioned between the high and low frequency bands has substantially 0 level. With this construction, the DTMF signal can be detected more reliably.

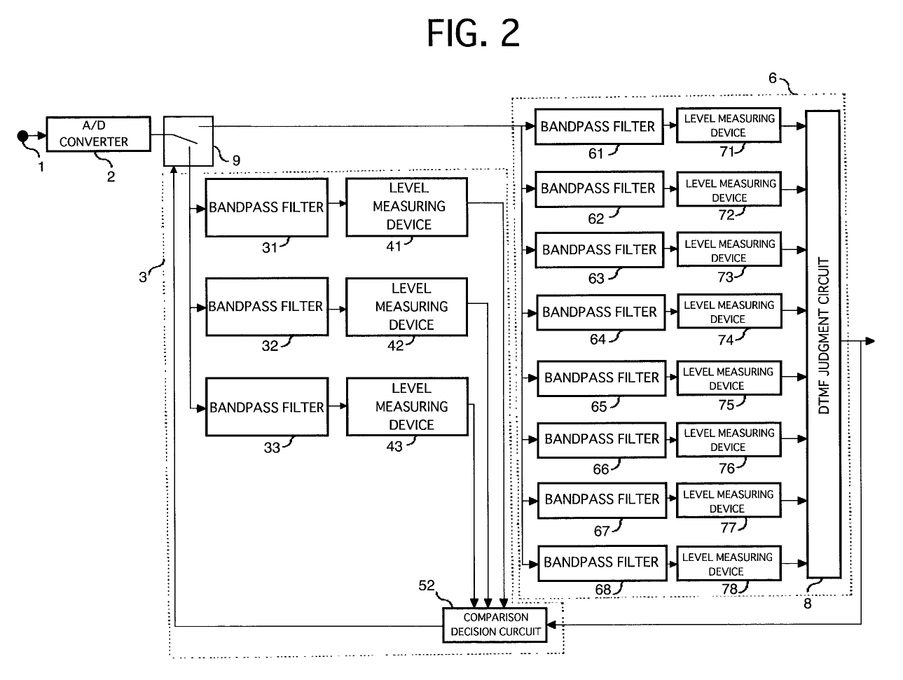

FIG. 2 is a view showing the construction of a DTMF decoder of the second embodiment.

The second embodiment has a bandpass filter 33 having a passband which is the middle tone frequency (942 Hz to 1208 Hz) between the low tone frequency and a high tone frequency and a level measuring device 43 in addition to the construction of the DTMF decoder of the first embodiment. Further, there is a comparison decision circuit 52 instead of the comparison decision circuit 51 of the DTMF decoder of the first embodiment.

The DTMF decoder judges and outputs a DTMF signal if the DTMF signal is included in an input signal. If the DTMF signal is not included in the input signal, nothing is outputted.

The operation of the DTMF detecting circuit of the second embodiment is now described In the initial state, the switch 9 is set in the manner that the output of the A/D converter 2 is inputted to the bandpass filters 31, 32 and 33.

An input signal from the input terminal 1 is converted into a digital signal by the A/D converter 2. The digital signal is inputted to the bandpass filter 31, the bandpass filter bandpass filter 32 and the bandpass filter 33.

The bandpass filter 31 outputs a passed signal of the low tone frequency and the passed signal is inputted to the level measuring device 41. The bandpass filter 32 outputs a passed signal of the high tone frequency and the passed signal is inputted to the level measuring device 42. The bandpass filter 33 outputs a passed signal of a tone frequency between the high and low tone frequencies and the passed signal is inputted to the level measuring device 43.

The level measuring device 41, the level measuring device 42 and the level measuring device 43 detect levels of the inputted passed signals and output these levels. Three kinds of levels are respectively inputted to the comparison decision circuit 52.

The comparison decision circuit 52 decides that the DTMF signal is included in the digital signal if the output level of the level measuring device 41 and that of the level measuring device 42 are respectively more than a given level at the same time and substantially the same while the output level of the level measuring device 43 is scarcely present. In other cases, the comparison decision circuit 52 decides that the DTMF signal is not included in the digital signal. The comparison decision circuit 52 switches the switch 9 immediately after deciding that the DTMF signal is included in the digital signal so as to allow the digital signal outputted from the A/D converter 2 to be inputted to the DTMF decoder 6. The comparison decision circuit 52 keeps monitoring the levels outputted from the level measuring device 41, 42 and 43 when deciding that the DTMF signal is not included in the digital signal.

When the switch 9 is switched to the DTMF decoder 6, the digital signal outputted from the A/D converter 2 is inputted to the bandpass filters 61 to 68. The bandpass filters 61 to 68 output passed signals of respective passbands when the digital signal passes therethrough. The passed signals are inputted to the level measuring devices 71 to 78 connected to the bandpass filters 61 to 68. The level measuring devices 71 to 78 detect levels of the passed signals of the corresponding passbands and output these levels.

Two level measuring devices which output levels having more than a given value for more than a given time (40 ms according to DTMF standard) are selected by the DTMF judgment circuit 8. A signal obtained by combining two passed signals of two passbands corresponding to the selected level measuring devices is a DTMF signal included in the input signal. The DTMF judgment circuit 8 outputs a numeral corresponding to the DTMF signal as an output of the DTMF decoder of the invention.

If the number of level measuring device output levels of which are more than a give value for more than a given time (40 ms according to the DTMF standard) is other than two, the DTMF judgment circuit 8 decides that the signal inputted to the DTMF decoder 6 is not the DTMF signal and it does not output anything.

The output of the DTMF judgment circuit 8 is also inputted to the comparison decision circuit 52. The comparison decision circuit 52 switches the switch 9 so that the output of the A/D converter 2 is inputted to the bandpass filters 31, 32 and 33 if a numeral corresponding to the DTMF signal is outputted from the DTMF judgment circuit 8 or an output from the DTMF judgment circuit 8 is not present for more than a given time (e.g. 50 ms) after the switch 9 is switched. That is, the decoding of the DTMF signal relative to the next input signal starts.

Accordingly, in the DTMF decoder of the second embodiment of the invention, the DTMF signal is decoded only in case where the DTMF signal is detected by the DTMF detecting circuit 3. Since the decision of the presence of the DTMF signal is performed using bandpass filters number of which is less than that of the DTMF decoder 6, the power consumption of the DTMF decoder of the second embodiment of the invention is less than that of the conventional DTMF decoder.

Further, since the accuracy of the DTMF detecting circuit 3 is enhanced, the accuracy of the DTMF decoder of the second embodiment is enhanced.

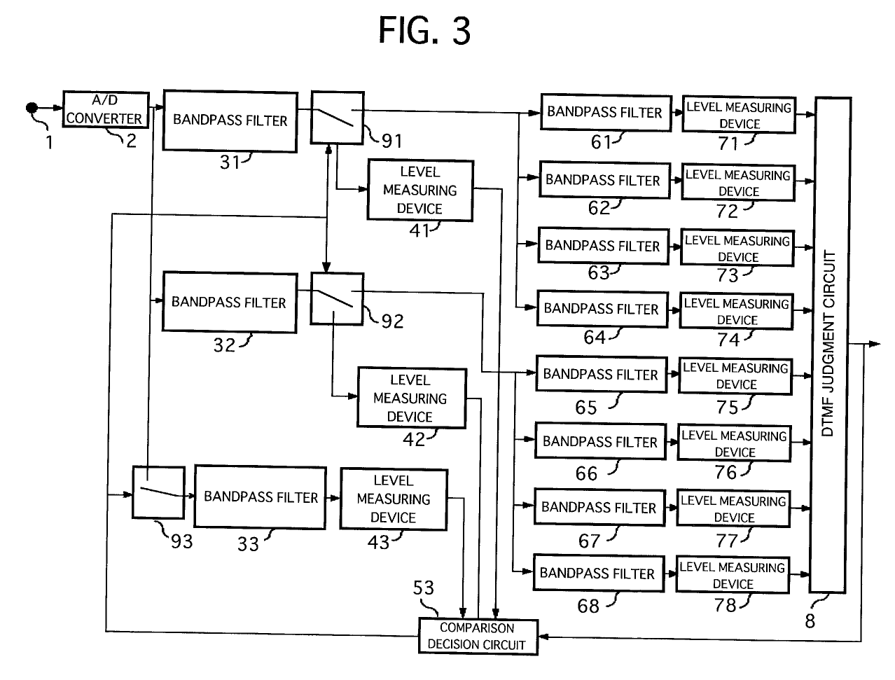

FIG. 3 is a view showing the construction of a DTMF decoder according to a third embodiment of the invention. Components having the same reference numerals as those of the second embodiment shown in FIG. 2 are the same as those of the second embodiment.

The DTMF decoder of the third embodiment includes connecting switches 91, 92 and a switch 93 for switching between ON and OFF.

An input terminal of the switch 91 is connected to a bandpass filter 31. An output from one output terminal of the switch 91 is respectively inputted to bandpass filters 61 to 64 which are connected in parallel with one another. The other output terminal of the switch 91 is connected to a level measuring device 41. When the switch 91 is switched, the output destination is switched to either the bandpass filters 61 to 64 or the level measuring device 41.

An input terminal of the switch 92 is connected to a bandpass filter 32. An output from one output terminal of the switch 92 is respectively inputted to bandpass filters 65 to 68. The other output terminal of the switch 92 is connected to a level measuring device 42. When the switch 92 is switched, the output destination is switched to either the bandpass filters 65 to 68 or the level measuring device 42.

The switch 93 is connected between the A/D converter 2 and the bandpass filter 33. That is, if the switch 93 is ON, the output of the A/D converter 2 is supplied to the bandpass filter 33 while if the switch 93 is OFF, the output of the A/D converter 2 is not supplied to the bandpass filter 33.

The control for switching the switches 91, 92, and 93 is performed by a comparison decision circuit 53.

In the initial state, the output of the switch 91 is routed to the level measuring device 41, and the output of the switch 92 is routed to the level measuring device 42 while the switch 93 is ON.

The operation of the DTMF decoder circuit according to the third embodiment is now described.

An input signal from the input terminal 1 is converted into a digital signal. The digital signal outputted from the A/D converter 2 is inputted to the bandpass filters 31 and 32. Further, since the switch 93 is ON at first, the digital signal outputted from the A/D converter 2 is inputted to the bandpass filter 33.

The bandpass filter 31 outputs a passed signal of the low tone frequency, and the passed signal is inputted to the level measuring device 41 via the switch 91. The bandpass filter 32 outputs a passed signal of the high tone frequency, and the passed signal is inputted to the level measuring device 42 via the switch 92. The bandpass filter 33 outputs a passed signal of a tone frequency between the high and low tone frequencies, and the passed signal is inputted to the level measuring device 43.

The level measuring devices 41, 42 and 43 detect the levels of the passed signals respectively inputted thereto and output these levels. These kinds of levels are inputted to the comparison decision circuit 53.

The comparison decision circuit 53 decides that the DTMF signal is included in the digital signal if the output level of the level measuring device 41 and that of the level measuring device 42 are respectively more than a given level at the same time and substantially the same while the output level of the level measuring device 43 is scarcely present. In other cases, the comparison decision circuit 53 decides that the DTMF signal is not included in the digital signal. The comparison decision circuit 53 switched the switches the switch 91 and 92 to the other connecting terminals immediately after deciding that DTMF signal is included in the digital signal, then turning off the switch 93. As a result, the passed signal outputted from the bandpass filter 31 is inputted to the bandpass filters 61 to 64 while the passed signal outputted from the bandpass filter 32 is inputted to the bandpass filters 65 to 68. The comparison decision circuit 53 keeps monitoring the levels outputted from the level measuring devices 41, 42 and 43 when deciding that the DTMF signal is not included in the digital signal.

Passed signals of respective passbands are outputted from the bandpass filters 61 to 64 and 65 to 68. Respective passed signals are inputted to the level measuring devices 71 to 74 connected to the bandpass filters 61 to 64 and the level measuring devices 75 to 78 connected to the bandpass filters 65 to 68. The level measuring devices 71 to 78 detect levels of the passed signals of the corresponding passbands and output these levels.

One level measuring device of the level measuring devices 71 to 74 having more than a given value for more than a given time (40 ms according to the DTMF standard) and one level measuring device of the level measuring devices 75 to 78 having more than a given value for more than a given time, namely, two level measuring devices in total are selected by the DTMF judgment circuit 8. A signal obtained by combining passed signals of two passbands corresponding to the selected level measuring devices is a DTMF signal. The DTMF judgment circuit 8 outputs a numeral corresponding to the DTMF signal as an output of the DTMF decoder of the invention.

The output of the DTMF judgment circuit 8 is also inputted to the comparison decision circuit 53. The comparison decision circuit 53 switches the switches 91 and 92 and turns on the switch 93 so that the output of the A/D converter 2 is inputted to the bandpass filters 31, 32 and 33 if a numeral corresponding to the DTMF signal is outputted from the DTMF judgment circuit 8 or an output from the DTMF judgment circuit 8 is not present for more than a given time (e.g. 50 ms) after the switch 9 is switched. That is, the decoding of the DTMF signal relative to the next input signal starts.

As mentioned above, according to the invention, the decision whether the DTMF signal is included in the input signal is performed by three bandpass filters. Only in case where the DTMF signal is included in the input signal, the power which has been conventionally consumed for extracting the concrete tone frequency of the DTMF signal is used. As a result, the DTMF signal can be detected with less power consumption.

While particular embodiments of the invention have been described and illustrated, it should be understood that the invention is not limited thereto since modifications may be made by persons skilled in the art. The present application contemplates any and all modifications that fall within the spirit and scope of the underlying invention described and claimed herein.

What is claimed is:

1. A DTMF decoder comprising:
a first bandpass filter for extracting a signal of a low frequency band from an input signal;
a second bandpass filter for extracting a signal of a high frequency band from the input signal;
a first level measuring device for measuring a level of the signal of the low frequency band and outputting the same level;
a second level measuring device for measuring a level of the signal of the high frequency band and outputting the same level; and
a comparison decision circuit for outputting a signal indicating that a DTMF signal is included in the input signal only in case where the level of the signal of the low frequency band is substantially the same as that of the high frequency band.

2. A DTMF decoder comprising:
a first bandpass filter for extracting a signal of a low frequency band from an input signal;
a second bandpass filter for extracting a signal of a high frequency band from the input signal;
a third bandpass filter for extracting a signal of a middle frequency band from the input signal;
a first level measuring device for measuring a level of the signal of the low frequency band and outputting the same level;
a second level measuring device for measuring a level of the signal of the high frequency band and outputting the same level; and
a third level measuring device for measuring a level of the signal of the middle frequency band and outputting the same level; and
a comparison decision circuit for outputting a signal indicating that a DTMF signal is included in the input signal only in case where the level of the signal of the low frequency band is substantially the same as that of the high frequency band while the levels of the signals of the low frequency band and the high frequency band are higher than respective given values and the level of the signal of the middle frequency band is lower than a given value.

3. A DTMF decoder comprising:
a first bandpass filter for extracting a signal of a low frequency band from an input signal;
a second bandpass filter for extracting a signal of a high frequency band from the input signal;
a third bandpass filter for extracting a signal of a middle frequency band from the input signal;
a first level measuring device for measuring a level of the signal of the low frequency band and outputting the same level;
a second level measuring device for measuring a level of the signal of the high frequency band and outputting the same level; and
a third level measuring device for measuring a level of the signal of the middle frequency band and outputting the same level;
a comparison decision circuit for outputting a signal indicating that a DTMF signal is included in the input signal only in case where the level of the signal of the low frequency band is substantially the same as that of the high frequency band while the levels of the signals of the low frequency band and the high frequency band are higher than respective given values and the level of the signal of the middle frequency band is lower than a given value. low tone frequency extracting means for extracting a tone frequency of the signal of the low frequency band from the signal of the low frequency band and outputting the extracted tone frequency only in case where the output of the comparison decision circuit is a signal including the DTMF signal;
high tone frequency extracting means for extracting a tone frequency of the signal of the high frequency band from the signal of the high frequency band and outputting the extracted tone frequency only in case where the output of the comparison decision circuit is a signal including the DTMF signal; and
analyzing means for outputting a numeral corresponding to the DTMF signal comprising the tone frequency outputted from the low tone frequency extracting means and the tone frequency outputted from the high tone frequency extracting means.
